(19) United States
(12) Patent Application Publication
(10) Pub. No.: US 2005/0172492 A1
(43) Pub. Date: Aug. 11, 2005

(54) Electric shaver

(75) Inventors: Lawrence A. Blaustein, Moreland Hills, OH (US); Douglas A. Gall, Strongsville, OH (US); John William Nottingham, Bratenahl, OH (US)

Correspondence Address: FAY, SHARPE, FAGAN, MINNICH & MCKEE, LLP, 1100 SUPERIOR AVENUE, SEVENTH FLOOR, CLEVELAND, OH, 44114, US

(73) Assignee: Ridgewood Industries LLC

(21) Appl. No.: 10/774,279

(22) Filed: Feb. 6, 2004

(51) Int. Cl. B26B 19/02

(52) U.S. Cl. 30/43.92

(57) ABSTRACT

A high-speed low cost dry shaver includes a cutting assembly driven by a drive assembly. The drive assembly includes a motor and an associated drive shaft for operating the cutting reciprocations greater than eight thousand cycles per minute for the high-speed shearing operation. A replaceable battery supply is disposed within the shaver and operatively connected to the drive assembly as a sole supply of power to the drive assembly. Alternative rechargeable energy supplies are not included. A cam assembly is interposed between the motor and the cutting assembly for translating motor revolutions to cutting reciprocations. The cam assembly directly translates motor revolutions to the cutting reciprocations without reducing or enhancing operating cutting speeds. The shaver is included in a packaging assembly which makes a switch assembly of the shaver accessible to a user so that the user may move the switch assembly into a first operating position operable with only a continuous manual exertion while the shaver is disposed in the package for effecting a demonstrative operation. A second operating position of the switch assembly turns the shaver on, but can only be accessed after the shaver is removed from the packaging. The second operating position is inhibited from unintended acquisition by a protective portion of the packaging.

### BACKGROUND

The present development is directed to a dry shaver utilizing a replaceable energy supply for a motor wherein the motor is relatively high speed and directly drives cutting blade reciprocations. The development is also directed to a switch assembly for the shaver providing a “Try Me” operating mode while the shaver is in a packaging, and a distinct “on-off” mode when removed from the packaging.

Dry shavers, as opposed to wet shavers (a blade requiring a lubricating foam), require an energy supply for a motor to drive a cutting blade assembly which effectively operates to shear hair in the shaving operation. An outer shearing foil is disposed to engage the skin of a user and includes apertures to allow shearable hair to pass through the foil for the cutting operation as a reciprocating blade moves against the foil. The reciprocating movement of the cutting blade is effected by a transmission assembly interposed between a drive motor and a cutting blade. As it is desired that the reciprocations occur with a frequency in the range of thousands of cycles per second, such transmission assemblies have been constructed with a design intent to withstand the cyclical frequencies over a relatively long period of time. Many users keep their electric shavers for periods of years. The robust assembly requirements for such shavers tend to promote design objectives employing complex gearing assemblies, rechargeable battery supplies and minimized reciprocating speeds for the cutting blade, all for promoting a long, maintenance-free life of the shaver. It should be particularly noted that higher speed reciprocations of the cutting blade assembly, although enhancing shearing efficiencies, can be expected to engender more vibration, friction and heat within the cutting blade assembly, thereby diminishing the design objectives of a longer life and robustness.

The complexities of prior known dry shaver systems have resulted in a commercial market for such shavers dominated by relatively high cost products, having increased weight and bulk necessary to accommodate rechargeable battery systems, complex curing assemblies and ubiquitous vibration damping componentry.

There is a need for a simplified, yet still robust, low cost dry shaver that can provide an effective shaver operation through efficient shearing, while avoiding complex drive and gearing transmission assemblies, heavy and expensive rechargeable battery supplies, all in a lightweight and highly portable assembly.

Conventional dry shavers, as relatively expensive items, are normally packaged in a secure package precluding any access to the shaver in the packaging until a buyer has actually purchased the particular shaver. Certainly, demonstration models can be made available, but the demonstration models are not usually the particular shaver purchased by the buyer.

As the present development concerns a relatively low cost shaver, the merchandising of the shaver can be greatly facilitated by its enhanced exposure, accessability and operable demonstration by a prospective purchaser. Operation testing of a desired product within a blister pack for citing interest in a product and satisfying a prospective buyer's product curiosity is well known for a range of consumer-type goods. Demonstrability is usually identified to the consumer with a “Try Me” tag line on the product packaging encouraging the prospective purchaser to operate the product in a manner which demonstrates but does not weaken or damage the product itself, or its energy supply, and is sufficient to satisfy most questions about the operability of the product. Almost all blister pack configurations including the “Try Me” feature require relatively complex packaging configurations to preclude accidentally putting the product within the packaging into a permanent on operation, thereby eventually completely draining the battery supply. Protrusions or walls are disposed about a switch assembly to preclude the switch assembly from movement into the permanent operation while in the packaging. In addition, it is usually important that the blister pack wholly contain the product so that any “Try Me” type operation must be performed through a wall of a blister pack and, thus, there will be a necessary spacing between the product itself and the product being tested. The integrity of the containing packaging is particularly important when the contained product is health or food related.

There is a need for a dry shaver packaging assembly which allows a prospective buyer to have the advantage of a “Try Me” test mode prior to purchase, but can be accomplished without a complex blister pack arrangement especially designed for protecting undesired shaver operation.

The subject development satisfies the above-referenced needs and others to provide a low cost dry shaver that is highly efficient in its shearing, yet extremely portable and can be merchandised within a “Try Me” type packaging arrangement.

### SUMMARY

A portable electric shaver comprises a cutting assembly driven by a drive assembly. The drive assembly includes a motor and an associated drive shaft for operating the cutting assembly at cutting reciprocations greater than eight thousand cycles per minute for high-speed cutting operation. A replaceable battery supply is disposed within the shaver and connected to the drive assembly as a sole supply of power to the drive for generating motor revolutions matching the cutting reciprocations. A cam assembly is interposed between the motor and cutting assembly for causing the cutting reciprocations wherein the cam assembly includes an eccentric pin relative to the drive shaft and a gear assembly directly translates motor revolutions to the cutting reciprocations without reducing or enhancing operating cutting speeds.

The cutting assembly includes a swing bridge supporting an inner cutter and a support post fixed to the swing bridge and the inner cutter. The support post is aligned with the drive shaft and includes an aperture disposed relative to the eccentric pin for providing cam engaging surfaces whereby the cutting reciprocations of the inner cutter equal in frequency the revolutions of the drive shaft.

In accordance with another aspect of the present development, the shaver includes a switch for selectively operating the shaver wherein the switch includes a “Try Me” position for demonstrative operation prior to purchase.

In accordance with yet another more limited aspect of the present development, the shaver includes a cap for the cutting assembly wherein the cap includes a selectively removable cleaning brush mounted therein for cleaning of the blades of the cutting assembly.

In accordance with another aspect of the present development, a portable electric shaver is disposed in a packaging for facilitating selective demonstrative operation of the shaver within the packaging. The shaver comprises a switch having a first operating position operable only with a continuous manual exertion by a potential purchaser while the shaver is disposed in the packaging for demonstrative operation. A second operating position causes a cutting operation of the shaver without the continuous manual exertion for effecting an actual shaving operation for the user. The second operating position is inhibited from unintended operation by the packaging.

In accordance with a more limited aspect of the present development, the packaging includes an opening for a user to move the switch to the first operating position. A packaging wall is disposed adjacent the opening to inhibit the movement of the switch to the second operating position so long as the shaver remains in the packaging.

It is a particular object of the present development to provide a low cost high speed, extremely portable dry shaver powered by removable batteries, such as a pair of AA batteries. The shaver has a particular advantage of being packaged within a packaging assembly which allows selective demonstrative operation of the shaver within the packaging for improved ease and accuracy of understanding the shaver operation.

These and some other objects and advantageous of the development will become more apparent from the following description of the preferred embodiments.

### BRIEF DESCRIPTION OF THE DRAWINGS

FIG. 1 is a front perspective view of the subject dry shaver;

FIG. 2 is an exploded assembly view, in perspective, of the shaver;

FIG. 3 is a perspective view showing the shaver trimming blade in an open operable position;

FIG. 4 is a partially assembled perspective view for particularly showing the cutting assembly received in a swing bridge and mounted within the shaver shell;

FIG. 5 is a cross-sectional planar view showing the batteries, motor, cam assembly and cutting assembly as received in the shaver shell;

FIG. 6 is a side elevational view demonstrating the cross-sectional view of FIG. 5 as taken along line 5-5 of FIG. 6;

FIG. 7 is a partial cross-sectional view showing the trimmer positioning assembly and a partial view of the switch assembly;

FIG. 8 is a partial cross-sectional view particularly illustrating the drive mechanism for the trimmer blade and cutting assembly;

FIG. 9 is a diagrammatic view illustrating the switch assembly in selected switch positions;

FIG. 10 is an exploded planar view of the cutting assembly in association with the cam assembly and drive motor;

FIG. 11 is an exploded perspective view of the elements of FIG. 10;

FIG. 12 is a perspective view of an end cap of the shaver;

FIG. 13 is an exploded view of a shaver cap particularly showing the cleaning brush removed from its mounting position in the cap;

FIG. 14 is a perspective view of the shaver received in a packaging assembly; and

FIG. 15 is a cross-sectional elevational view particularly showing accessability of the switch assembly of the razor within the packaging assembly.

### DESCRIPTION OF THE PREFERRED EMBODIMENTS

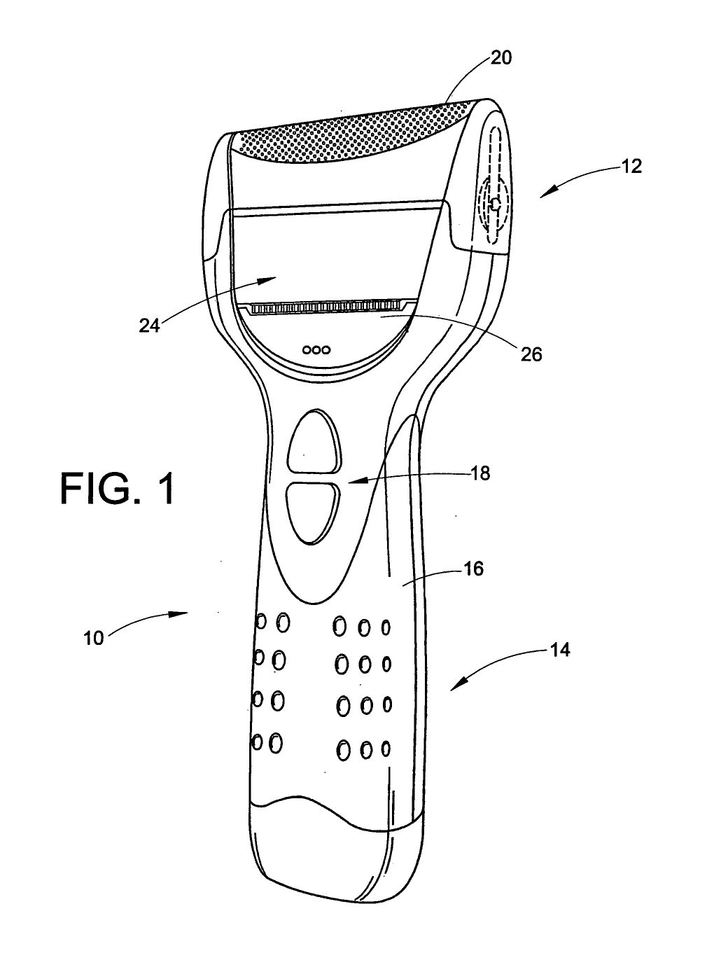

With reference to FIG. 1, an elevated perspective view of the subject electric dry shaver 10 is shown to include a cutting assembly portion 12 and a handle portion 14. The handle portion includes an elongated grip 16 conveniently sized for one-handed manipulation during operational use. The handle portion also includes switch assembly 18 for the selective on-and-off operation of the shaver.

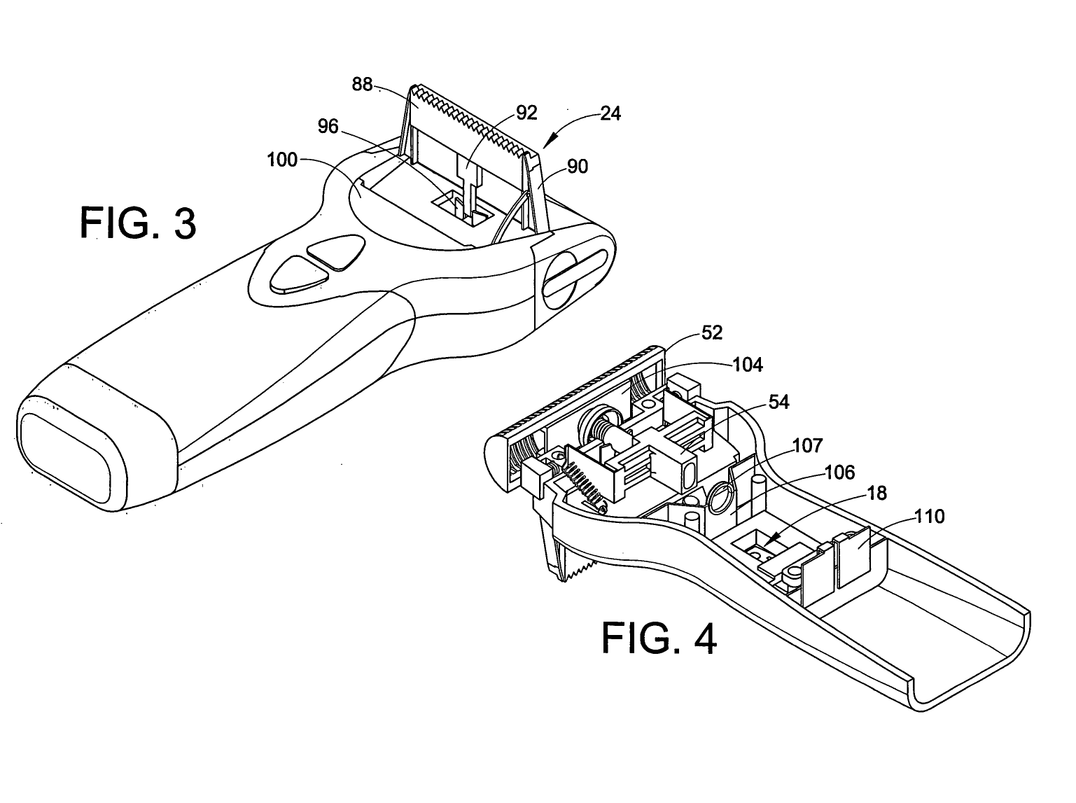

The cutting assembly portion 12 preferably includes a screen 20 preferably comprising a metallic foil or the like, though other materials could be employed so long as they provide a relatively thin apertured engaging surface to provide close and accessible shearing of hair, such as a man's beard. A trimmer assembly 24 provides a selectively operational hair trimmer which is positionable between a closed position wherein the trimming blade is latched within the cutting assembly portion 12, or may be released by trimmer release plate 26 to project perpendicularly from the cutting assembly portion 12 when in the intended operational position (FIG. 3). It can be appreciated from FIG. 1 that the subject shaver presents an expanded cutting assembly portion which tapers to a narrowed handle configuration intended for a more ergonomic configuration for the convenience of a user.

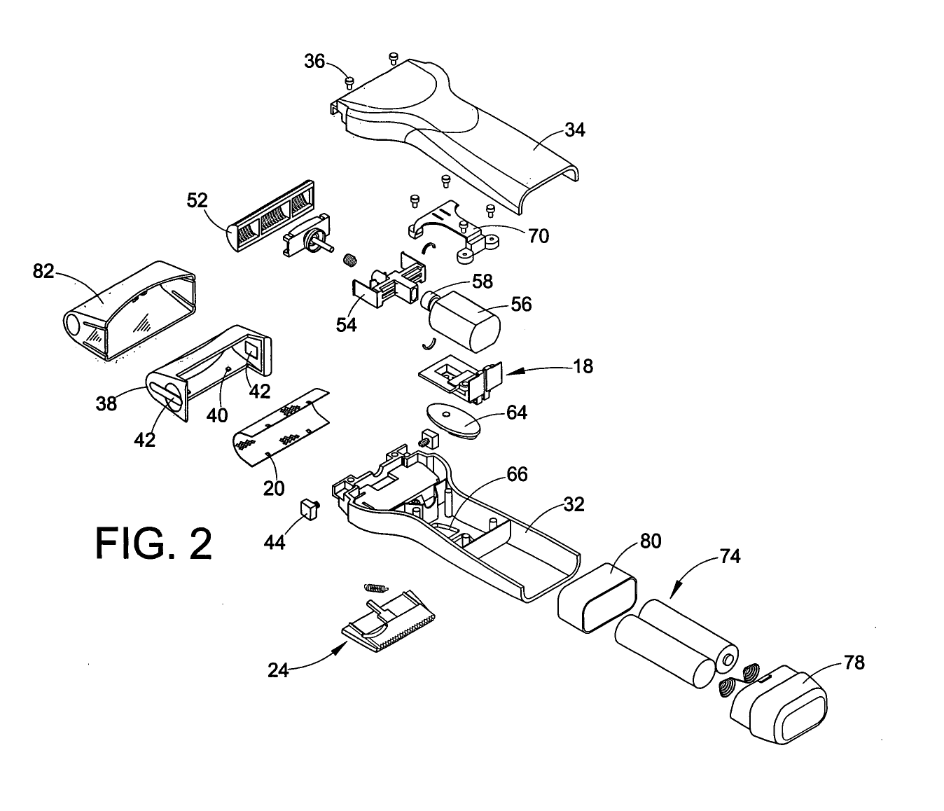

The componentry of the dry shaver is illustrated in exploded assembly in FIG. 2 for ease of illustration. The outer body of the shaver 10 is comprised of a clamshell configuration including a front shell 32 through which the switch assembly 18 is accessible to the user and a back shell 34 primarily comprising a back wall for the shaver. The shells 32, 34 are fastened together with conventional fastening devices 36. Screen 20 is held within the shaver by a foil holder 38 through tabs 40 on which the screen 20 is hung to present an arcuate disposition generally conforming to the cutting blades 52 for providing an intimate shearing surface as will hereinafter be more fully described. The foil holder 38 and screen 20 attached thereto can be selectively attached and removed (for cleaning or replacement) to and from the shells 32, 34 with opposed lock tabs 42 disposed for sliding engagement over and past the spring loaded projection bosses 44.

The inner components of the cutting assembly portion 12 comprise the inner cutter or cutting blades 52, configured in a generally semi-circular outer periphery for close mating engagement of the screen 20, a swing bridge 54 for generally supporting the cutting blades 52 and a motor 56 having a shaft on which is received a cam 58 which reciprocates the swing bridge 54 and thereby the cutting blades 52 for the desired reciprocating shearing action during operation of the shaver. Power to the motor is controlled by a switch assembly 18 which is actuated by a switch button pad 64 accessible through aperture 66 in the front shell 32. The motor is secured in the shell 32 through a motor hold down plate attached to shell 32 with conventional fasteners as shown. Energy to the motor 56 is directed by the switch assembly 18 from batteries 74 serially connected through a wire connection 76 and held within the shell battery compartment by an end cap 78. A selectively includable battery cover seal 80 can protect the batteries from water contact and consequent corrosion.

A high-speed motor is preferred, i.e., about eight to ten thousand revolutions per minute. When such a speed is translated to cutting assembly reciprocations, a high efficiency shearing operation is obtained.

Other components shown in FIG. 2 comprise the foil cover guard 82 and the trimmer assembly 24.

FIGS. 3 and 4 better illustrate the disposition of the trimmer assembly 24. In FIG. 3 the trimmer is released to an operable position wherein a moving blade 88 disposed adjacent to fixed blade 90 presents a shearing surface useful for trimming longer hairs. The moving blade 88 depends from a support post 92 received between two swing bridge prongs 96. The prongs 96 are part of the bridge 54 and thus as bridge 54 reciprocates, the prongs 96 reciprocate and the post 92 and blade 88 correspondingly reciprocate. When this trimmer is closed, the post 92 rotates away from the prongs 96 to preclude movement of the moving blade 88.

FIG. 4 also illustrates a biasing spring 98 which will urge the trimmer assembly into the position of FIG. 3 upon manual release of locking cam plate 26.

FIG. 4 illustrates that the cutting blades 52 are attached to a post pad 104 and can be selectively removed from the pad 104 for replacement or cleaning. The motor shaft is aligned relative to the swing bridge 54 with a positioning wall 106 and grommet 107 for accurately positioning the motor neck through which the motor shaft extends in the appropriate position. Contact pads 110 serially communicate energy from the batteries through the switch assembly 18 to the motor 56.

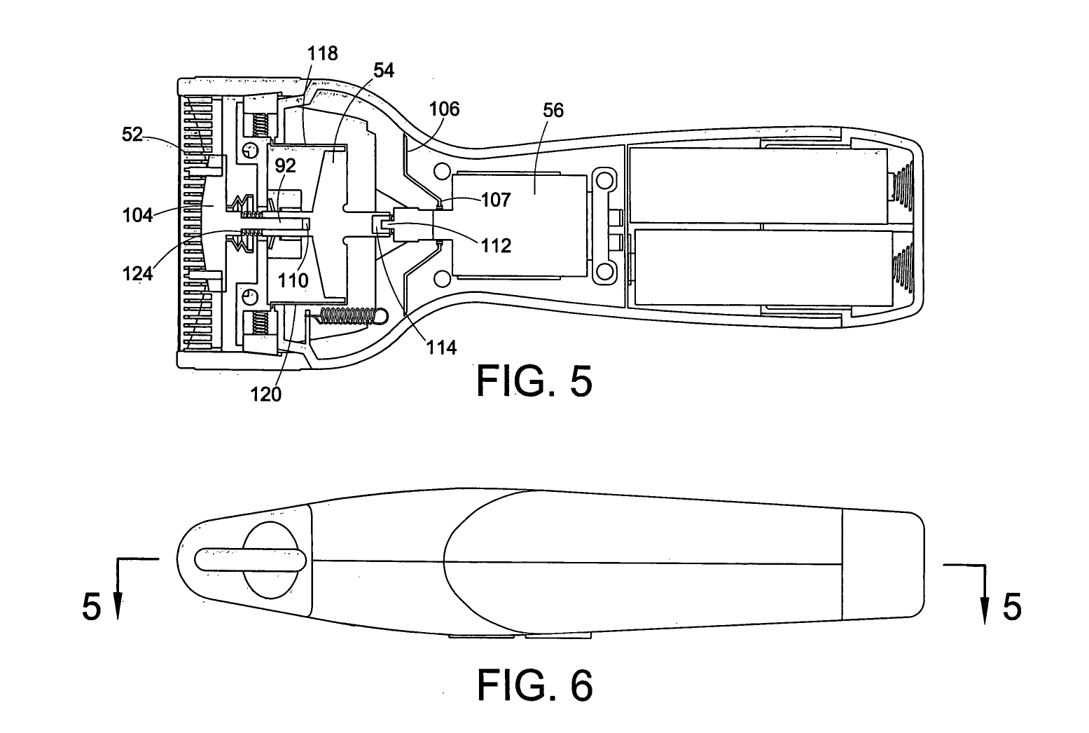

With reference to FIGS. 5 and 6, the cross-sectional view of FIG. 5 more clearly illustrates the cooperating alignment between the motor 56, swing bridge 54 and cutting blades 52. More particularly, post 92 is received in swing bridge aperture 110 along the same line as cam pin 112 is received in swing cam aperture 114. As the cam pin rotates around and in correspondence with the motor shaft, the pin 112 will only engage two of the side walls of aperture 114 because aperture 114 is sized to be elongated in the direction generally perpendicular to the width of the swing bridge shown in FIG. 5. In other words, the swing bridge 54 will only reciprocate along the line generally parallel to the length of the cutting blades 52 so that the cutting blades will reciprocate against the screen 20 in one direction only. Swing bridge 54 swings within the cutting assembly portion 12 from flexible swing bridge legs 118, 120. The blade carrier 104 is biased by spring 124 so that the cutting blades 52 are constantly urged against the screen 20.

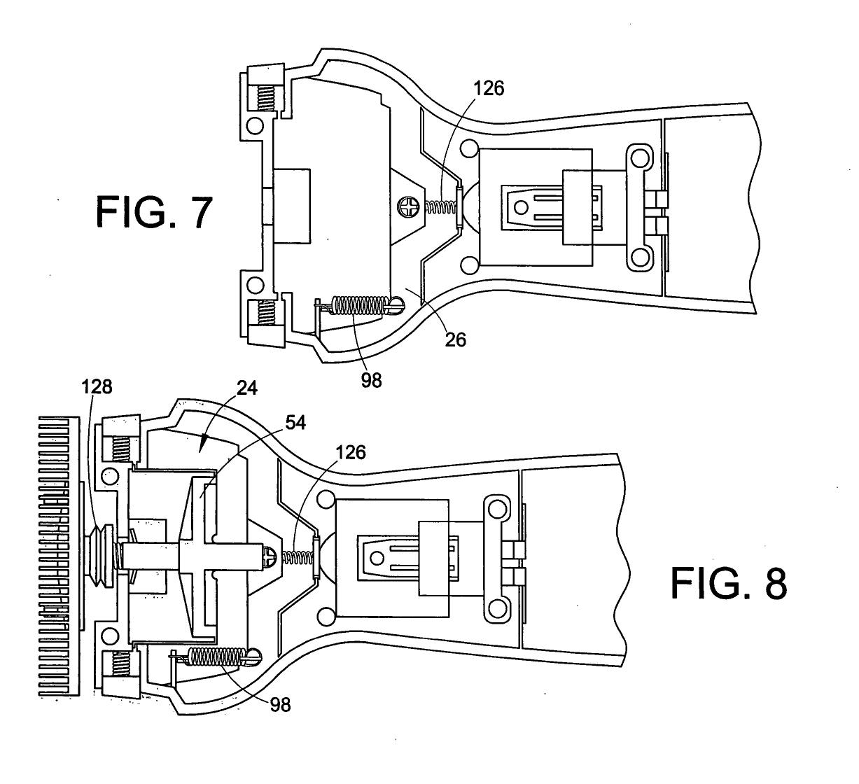

With particular reference to FIGS. 7 and 8, the trimmer release spring 98 urges the trimmer to the open position shown in FIG. 3. It is held in the closed position shown in FIG. 6 by release plate 26 which locks the trimmer in the closed position and holds it in position due to the urging of locking spring 126. FIG. 8 also clearly shows that the intercomponentry of the cutting assembly comprising a swing bridge 54 is sealed against cut hair or other debris by elastomeric seal 128.

FIGS. 10 and 11 comprise exploded views of the cutting assembly 12 and motor 56. It can be seen that the aperture 114 in the swing bridge is sized so that the cam pin 112 only engages side walls 130, 132 to translate the revolving motion of the cam 112 into the reciprocating action of the swing bridge. In order to minimize vibrations, the cam 58 includes an equal and opposite offset weight within the cam to balance against eccentric pin 112. Preferably, the offset comprises a variable density construction of the cam, as opposed to an additional component to balance out the pin 112. The cam assembly thus causes the same number of cutting reciprocations as motor revolutions and directly translates the motor revolutions to the cutting reciprocations without reducing or enhancing operating cutting speeds.

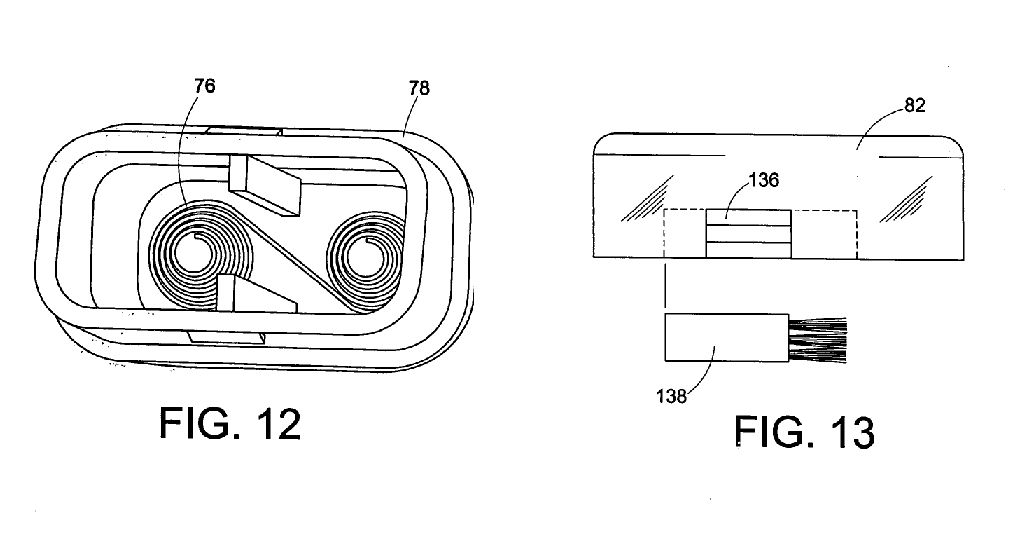

FIG. 12 shows the end cap which can be selectively removed from the fastened front and back shell 32, 34 for insertion replacement of the batteries. Cover guard 82 includes in its side wall a mount 136 for snap reception and holding of cleaning brush 138. When the cap 82 is removed from the shaver 10 during use of the shaver, the brush can remain stored in the cap, or can be removed for cleaning of the screen 20 or cutting blades 52 after shaver use.

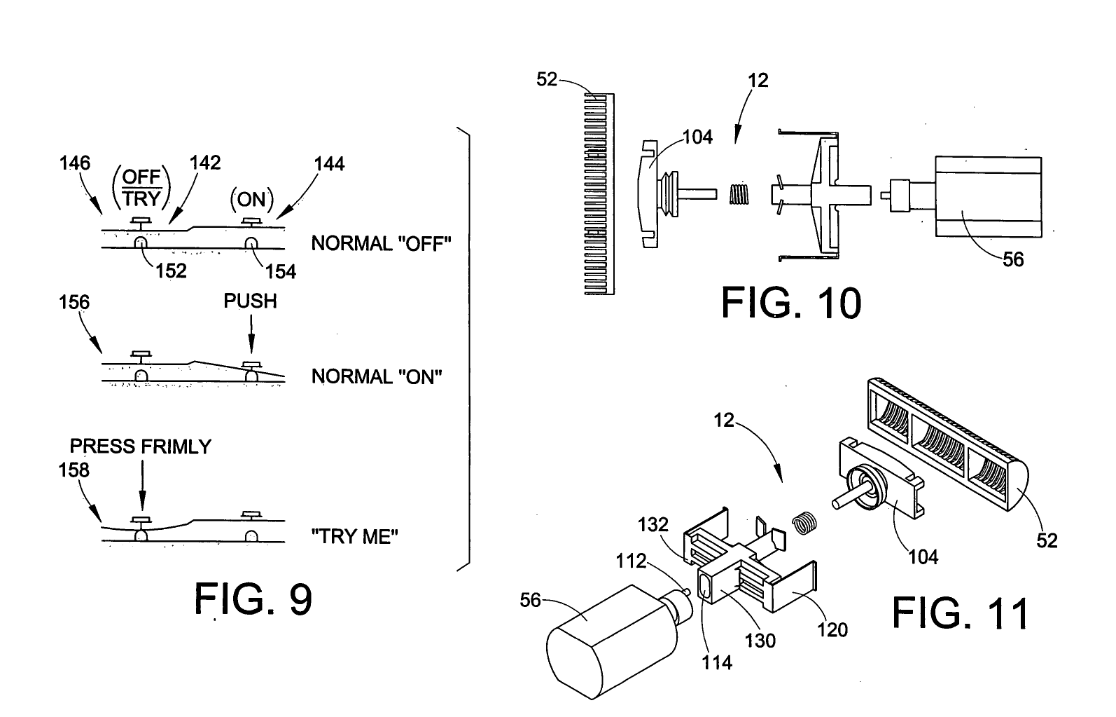

With particular reference to FIG. 9, it is a feature of the shaver that is disposed in a packaging for facilitating selective demonstrative operation while remaining in the packaging. Switch assembly 18 comprises a leaf-spring type switch which closes an electric circuit between the batteries 10 and the motor in either of two positions. In switch arrangement 146 the switch spring 150 is spaced from the contacts 152, 154 to present an open circuit, i.e., the “normal off” switch disposition. In arrangement 156, switch 144 has been pushed so that the spring 150 is snapped closed to present a closed circuit with contact 154. In this position, there is no need for a user to continue to push switch pad 144 as the shaver will remain in this normal on position during use. Switch configuration 158 illustrates user operation to turn the shaver off or demonstrate its operation while in the packaging. A continuous manual exertion by a potential purchaser of switch pad 142 results in the closing of the circuit for the “Try Me” operation. The pressing on switch 142 can also cause a snapping of the spring away from contact 154 and upon release of switch pad 142 by the user will cause the circuit to go into the normal off position of arrangement 146.

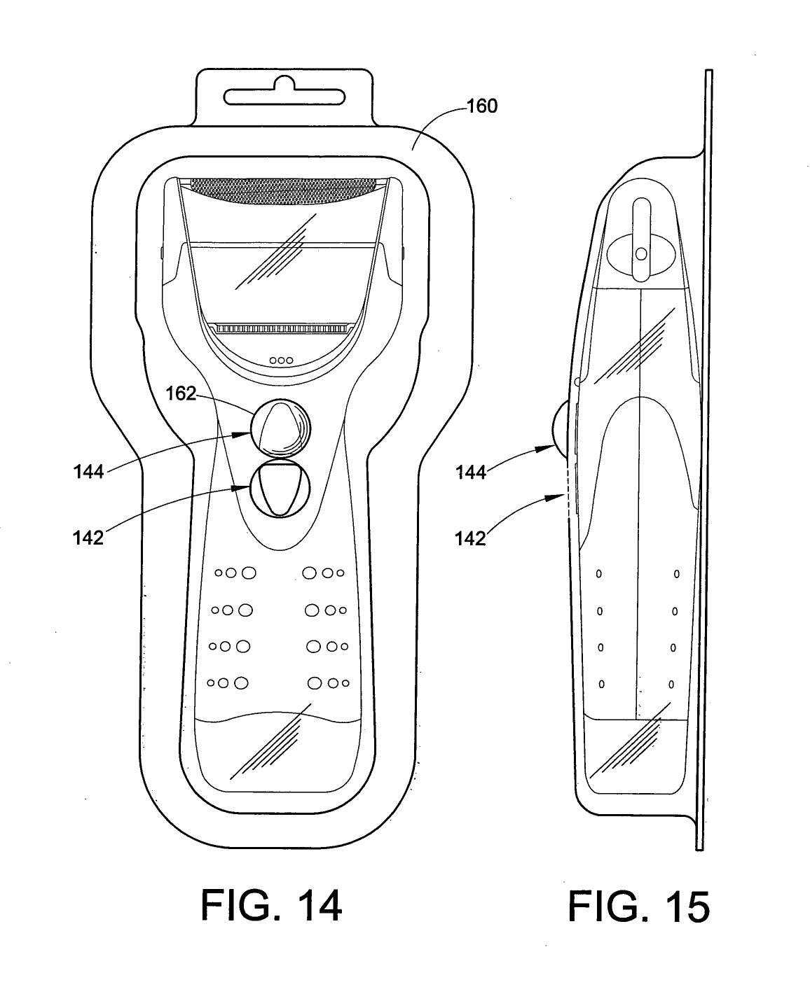

With reference to FIGS. 14 and 15, the demonstrative operation of the shaver within the packaging 160 can be seen. Arrangement 158 can only be caused by a user while the shaver 10 remains in the packaging 160. The continuous manual exertion by a user on pad 142 will cause the shaver to run while in the packaging. When the user releases switch pad 142, the switch assembly will return to arrangement 146, the normal off position. The packaging 160 protects against the shaver being turned into the normal on operating position 156 by a protective bubble 162 which safely spaces a user or contacting object from mistakenly being able to contact switch pad 144. Preferably, packaging 160 comprises a clear blister-pack type configuration in which the shaver, including the switch pads 142 or 144 and the cutting assembly portion 12 are clearly invisible to the user.

While the present development has been described with reference to various embodiments, it is not to be limited to the details set forth above, for it is intended to cover such modifications or changes as can be made within the scope of the attached claims.

1. A portable electric shaver comprising:
a cutting assembly driven by a drive assembly, the drive assembly including a motor and an associated drive shaft for operating the cutting assembly at cutting reciprocations greater than eight thousand cycles per minute for a high speed cutting operation;
a replaceable battery power supply disposed within the shaver and operatively connected to the drive assembly as a sole supply of power to the drive assembly for effecting motor revolutions matching the cutting reciprocations; and,
a transmission assembly interposed between the motor and the cutting assembly for effecting the cutting reciprocations.

2. The shaver as claimed in claim 1 wherein the transmission assembly comprises a cam assembly including an eccentric pin relative to the drive shaft and the cam assembly directly translates motor revolutions to the cutting reciprocations without reducing or enhancing operating cutting speeds.

3. The shaver as claimed in claim 1 wherein the replaceable battery supply comprises two AA-sized batteries.

4. The shaver as claimed in claim 1 including a switch for selectively operating the shaver wherein the switch includes a try me position for demonstrative operation prior to purchase.

5. The shaver as claimed in claim 1 wherein the cutting assembly includes a swing bridge supporting an inner cutter, and a support post fixed to the swing bridge and the inner cutter and aligned with the drive shaft, the support post including an aperture disposed relative to the eccentric pin for providing cam-engaging surfaces therefor whereby the cutting reciprocations of the inner cutter equal in frequency the revolutions of the drive shaft.

6. The shaver as claimed in claim 1 wherein a removable cap is disposed over the cutting assembly, the cap including a removable cleaning brush secured thereto.

7. A portable electric shaver disposed in a packaging for facilitating selective demonstrative operation of the shaver within the packaging comprising a switch having a first operating position operable while the shaver is disposed in the packaging for effecting the demonstrative operation and a second operating position for effecting a cutting operation of the shaver while the shaver is disposed out of the packaging for normal operational use, the second operating position being inhibited from unintended acquisition by the packaging and the first operating position being accessible through an opening in the packaging.

8. The shaver as claimed in claim 7 wherein the first operating position is operable with only a continuous manual exertion by a potential purchaser and the second operating position is operable without the continuous manual exertion.

9. The shaver as claimed in claim 7 wherein the packaging includes a wall adjacent the opening to effect the inhibiting of movement of the switch to the second operating position so long as the shaver remains in the packaging.
